(19) United States
(12) Patent Application Publication
(10) Pub. No.: US 2012/0221403 A1
(43) Pub. Date: Aug. 30, 2012

(54) MERCHANT INTERFACE FOR ONLINE COUPON SYSTEM

(76) Inventors: Michael Brown, Los Gatos, CA (US); Scott Urban, Los Gatos, CA (US)

(21) Appl. No.: 13/406,505

(22) Filed: Feb. 27, 2012

Related U.S. Application Data
(60) Provisional application No. 61/446,841, filed on Feb. 25, 2011.

(51) Int. Cl. G06Q 30/02

(52) U.S. Cl. 705/14.35

(57) ABSTRACT

A merchant interface for creating an online coupon is described. The interface can include controls to specify a location, time interval and one or more deal terms. Various embodiments of the merchant interface can include other options and details such as the ability to specify multiple deal locations, enforce redemption by Global Positioning Satellite (GPS) location, etc.

### CLAIM OF PRIORITY AND RELATED APPLICATIONS

This application claims priority from a U.S. provisional patent application entitled “METHOD AND SYSTEM FOR REAL-TIME LOCATION IDENTIFICATION, TRANSMISSION OF DISCOUNT INFORMATION, AND TOUCH-SCREEN PURCHASING & REDEEMING THROUGH USE OF A PORTABLE DEVICE,” Application No. 61/446,841, filed Feb. 25, 2011, which is hereby incorporated by reference for all purposes.

This application is related to the following U.S. patent applications which are each incorporated by reference as if set forth in full in this document for all purposes:

1. U.S. patent application Ser. No. ______ [TBD] filed on Feb. 27, 2012, entitled “METHOD AND SYSTEM FOR REAL-TIME LOCATION IDENTIFICATION, TRANSMISSION OF DISCOUNT INFORMATION, AND TOUCH-SCREEN PURCHASING & REDEEMING THROUGH USE OF A PORTABLE MULTIFUNCTION DEVICE”;

2. U.S. patent application Ser. No. ______ [TBD] filed on Feb. 27, 2012, entitled “ONLINE COUPON SYSTEM INCLUDING MERCHANT MANAGEMENT OF AN ACTIVE DEAL”

### TECHNICAL FIELD

Example embodiments relate to the field of applications for electronically offered deals (“coupons”) purchased and redeemed through the use of a user interface on a portable multifunctional device or web site. More specifically, the example embodiments relate to electronically offered discounts provided by electronic commerce (“e”-commerce) systems and media platforms which may be portable multifunctional device (e.g., smart phone and iPad™,) or non-portable device (e.g., PC and Mac) to assist users in identifying, purchasing and redeeming electronically offered discounts in real time. Furthermore, merchants (sellers) set up, edit, or cancel discount offers in real time as determined by daily need.

### BACKGROUND OF THE INVENTION

Today there exist a few techniques for notifying potential customers of daily discounts or “daily deals”. The discounts are currently communicated through email, web sites, or applications downloaded to portable multifunctional devices or smart phones. For example, local restaurants can attempt to attract customers by offering daily deals such as spend $20.00 get $40.00 worth of food.

Yet these techniques are often only promoted as one-deal-per-day and come from multiple stores and services including, but not exclusively, restaurants. Therefore, in such an approach restaurant merchants (sellers) must wait until there is an opening to run their discount or coupon. And then when they do, it will only run for one day.

Potential customers who participate with these daily deal companies must decide if they choose to purchase in that one-option daily deal in their City. Typically, these daily deals are not set up or managed in real-time. These daily deals include multiple stores and services beyond restaurants as earlier stated. If the user determines to purchase the daily deal then they must wait until the following day to redeem their purchase. If a potential customer wants to immediately redeem a daily deal for a restaurant in their location, that option is not available.

A merchant (seller) may need additional safeguards to ensure that the online coupon purchased will be redeemed only one time and at an economic advantage to the seller in the manner in which the coupon was intended. A seller may want to offer a discount to a large group of potential customers at times when business is slow or to grow a new business. In other words, it may be advantageous for the seller to be in greater control of the time the discount will be offered, the place of redemption and the amount of the discount. Additionally, a seller may need to ensure that the distribution of discount offers does not become economically ineffective by continually offering the discount.

### BRIEF DESCRIPTION OF THE DRAWINGS

FIG. 1A is a block diagram illustrating an example portable multifunctional device with a touch-sensitive displays, non-portable devices, a server and customer and merchant interfaces.

FIG. 1B is a block diagram of an example portable multifunctional device.

FIG. 1C is a block diagram of an example server computer.

FIG. 2 illustrates a portable multifunctional device with a touch-sensitive display showing an example of the user interface and home screen identifying the user's location by GPS.

FIG. 3 illustrates an example discount offer detail screen including the GPS map displaying the merchant discount offers within a certain mile radius of the user.

FIG. 4 illustrates an example detailed description screen showing the discount offer including such features as the offer expiration date, and the total purchased in real time.

FIG. 5 illustrates an example user purchase screen showing the discount offer, a confirmation of purchasing information button and credit card information stored from profile.

FIG. 6 illustrates an example economization of the order screen used to redeem the purchased credits.

FIG. 7 illustrates an example detailed breakdown screen showing purchased credits not yet redeemed.

FIG. 8 illustrates an example individual credit detail screen showing in detail an individual credit to be redeemed by the merchant at the merchant's physical location.

FIG. 9 illustrates an example daily email on a non-portable device screen giving the user notification of the day's best deal and other discount offers in the area for that day in real time.

FIG. 10 illustrates an example home page accessed by a user or merchant to access the site information on a non-portable device.

FIG. 11 illustrates an example merchant site and the various options available once a merchant has registered.

FIG. 12 illustrates an example access screen showing how a merchant gains access to the merchant's particular site using password clearance or through a facebook account.

FIG. 13 illustrates an example discount creation screen showing the detailed information a merchant enters to post a discount offer on the server for portable multifunctional and non-portable devices.

FIG. 14 illustrates an example preview screen showing what a merchant might view as a preview of what the offer will look like to potential customers.

FIG. 15 is a flow chart illustrating the operation of an example embodiment.

### DESCRIPTION OF EXAMPLE EMBODIMENTS

### Overview

Example embodiments include a method and system for transmitting discount information from sellers in real time to a user's portable multifunctional device and a web site for the purpose of presenting, purchasing and redeeming the discount. In one example embodiment, an application is transmitted or downloaded to a portable multifunctional device (e.g., smart phone, personal digital assistant (PDA), iPad™, notebook subnotebook, gaming device, audio player, electronic reader, etc.) or non-portable device (e.g., desktop computer such as PC or Mac) to allow the device to display the current local restaurant discount offers such as an offering of a $10 for $20 value discount until 6 P.M.

In another embodiment, the discount information is sent to a non-portable platform (e.g., PC or Mac) to display the same information on a website. In another embodiment of the invention, the user will have the option of receiving the new offer featuring the best daily deal via daily email or text message notifying the user. The user can then open the email or text message and proceed to purchase and redeem any of the offers.

In another example embodiment, the restaurant merchants (sellers) use the same system as the users to access their profiles and company information through portable multifunctional devices (e.g., smart phones, personal digital assistant (PDA), iPad™, notebook subnotebook, gaming device, audio player, electronic reader, etc.) or non-portable devices (e.g., desktop computers such as PCs and Macs). The web site home page links the sellers to a private business section where they can upload, edit, or delete the discount offer in real-time as well as determine the parameters of the offer, e.g., its timeline, restrictions and description. In other words, if the seller determines a Tuesday afternoon to be a particularly slow time, the seller may opt to feature a discount offer every Tuesday afternoon for the next month which will appear when users go into the site or application looking for the best discount offer at that time.

Sellers can also access their weekly update report giving statistics and historical charts showing the success of the offer and comparisons to other competitive offers.

In another example embodiment, when a user makes a first purchase of a discount offer, the user must first complete his/her profile including credit card information linked to a paypal™ or other payment account. Once the profile is complete, a user may click or touch the particular offer of interest icon on the device screen and proceed through a number of steps to purchase the offer. Once the purchase is complete, it appears as a credit and is accessible and redeemable at the restaurant or service provider that initiated the offer. Users are instructed to display the credit icon on the portable multifunctional device screen to the seller before placing an order with the establishment. The seller then touches the credit icon and the number goes from 1 to 0 indicating that the credit has been used. In other words, once the icon has been touched by anyone, the credit is used and cannot be reclaimed. Therefore, specific warning instructions are provided next to the icon reminding users that if they touch the icon before the merchant (seller) does, the credit will be lost and void.

When a user makes a purchase of a discount offer, the user's preferred credit card is billed and the stated dollar amount is transferred to a holding account of the managing company. The funds are then divided as stipulated in the agreement between the managing company and seller and stipulated funds are transferred to the merchant (seller) through a paypal™ or other payment account as previously set up in the sellers' profile.

In another example embodiment, when a merchant (seller) sets up a discount offer the merchant is competing with other merchants at any given time for the best offer in any given area or zip code. The best deal offered to the user on the day of interest becomes the best deal or deal of the day. This offer then becomes the first one on the list of offers to the user and is highlighted as the best deal. The seller has the ability, through the use of this system, of retrieving or pulling back or revoking discount offers in real time once it is determined that the discount is no longer needed. If the offer revoked was the best offer for that given day, the next best offer will move up in position in its place.

In another example embodiment, a merchant interface provides for creating and launching an online coupon. The merchant interface allows specifying a location, time interval and deal term. Once the coupon is defined and submitted via the merchant interface, the coupon is made viewable to user devices and a user can can redeem the online coupon.

### Description

Reference will now be made in detail to various example embodiments. These example embodiments are illustrated in the accompanying drawings. While the invention will be described in conjunction with these embodiments, it will be understood that it is not intended to limit the invention to any embodiment. On the contrary, it is intended to cover alternatives, modifications, and equivalents as may be included within the spirit and scope of the invention as defined by the appended claims. In the following description, numerous specific details are set forth in order to provide a thorough understanding of the various embodiments. However, the example embodiments may be practiced without some or all of these specific details. In other instances, well known process operations have not been described in detail in order not to unnecessarily obscure the present invention. Further, each appearance of the phrase “an example embodiment” at various places in the specification does not necessarily refer to the same example embodiment. Note, nothing described or referenced in this document is admitted as prior art to this application unless explicitly so stated.

Embodiments of applications executed by portable multifunctional devices, user interfaces for such devices, and associated processes for using such devices are described in detail. In some embodiments, the device is a portable communications device such as a mobile telephone that also contains other functions such as music player functions.

For simplicity, in the discussion that follows a multifunctional device that includes a touch screen is used as an example embodiment for executing the applications implementing example embodiments. A multifunctional portable device such as the iphone™ or similar device can be used to execute the applications of the present invention. The applications can also be executed in portable multifunctional devices that do not include a touch screen for inputting information, but rely instead on a more conventional mechanism such as point and click, keypad, or clock-wheel mechanism.

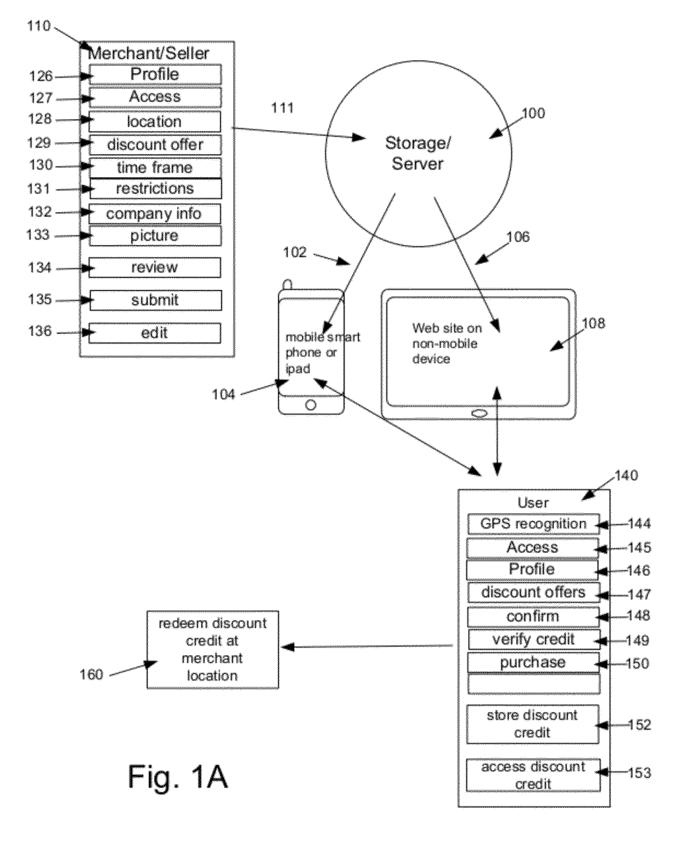

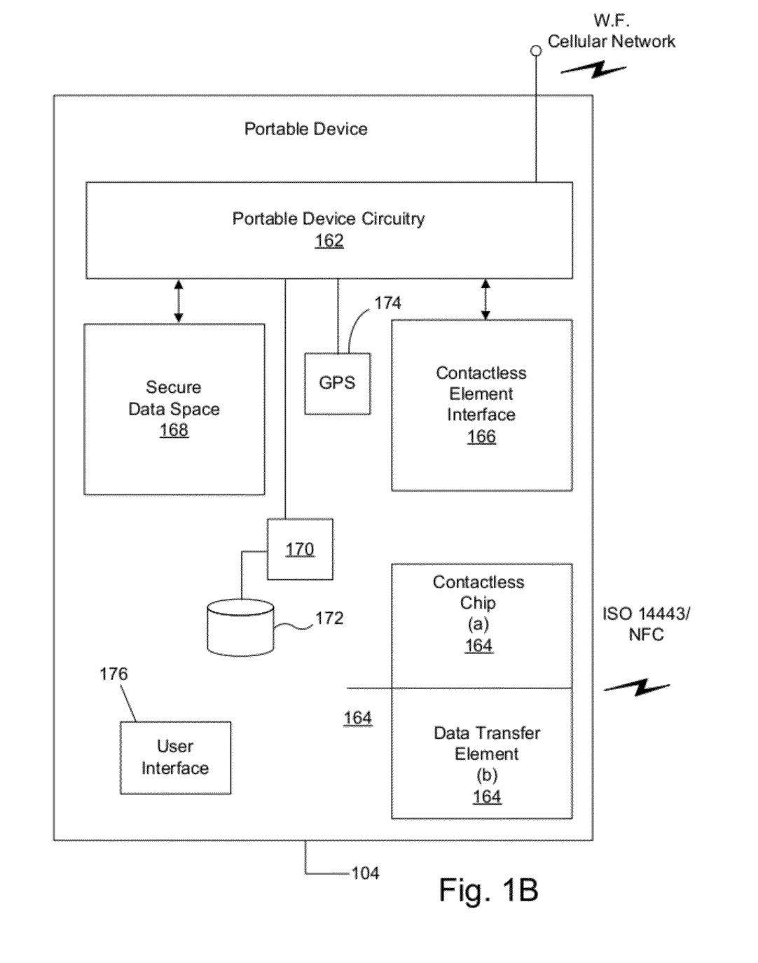

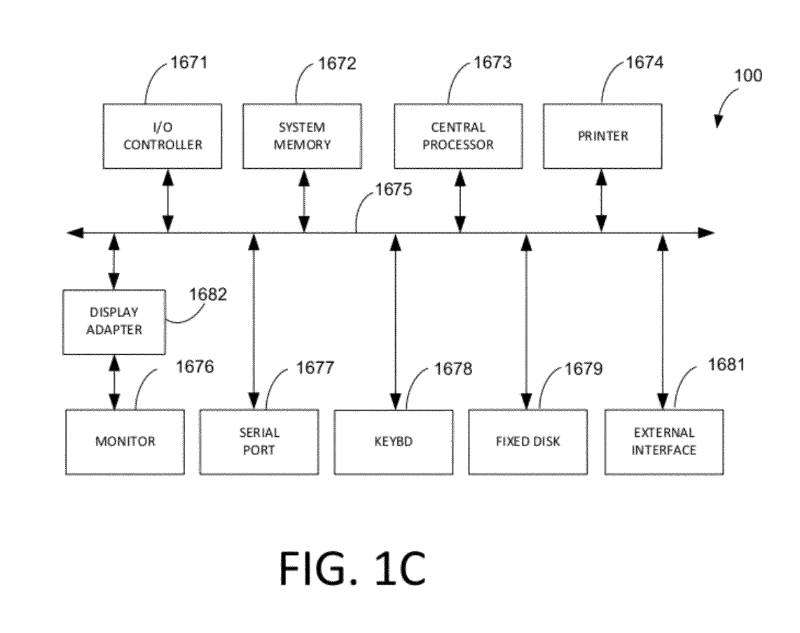

FIG. 1A is a block diagram of an example embodiment including storage/server computer 100, a first communication link 102 to a portable multifunctional device 104 and a second communication link 106 to a non-portable device 108 such as, for example, a personal computer.

The first communication link can also support WLAN communication according to the IEEE 802.11x group of standards, for example WPAN device communication including the Bluetooth interface standard or another WPAN standard such as the 802.15 standard. Accordingly, the first communication link is able to support all or a subset of cellular telephone, WLAN, and WPAN operations.

The second communication link 106 typically supports an internet connection but can also support any suitable WAN or LAN protocol.

FIG. 1A also depicts a Merchant/Seller interface 110 that allows the Merchant/Seller to interact with the storage/server computer. This interface can be implemented on either a personal computer or portable multifunctional device using a communication link 111 similar to one of the first or second communication links described above.

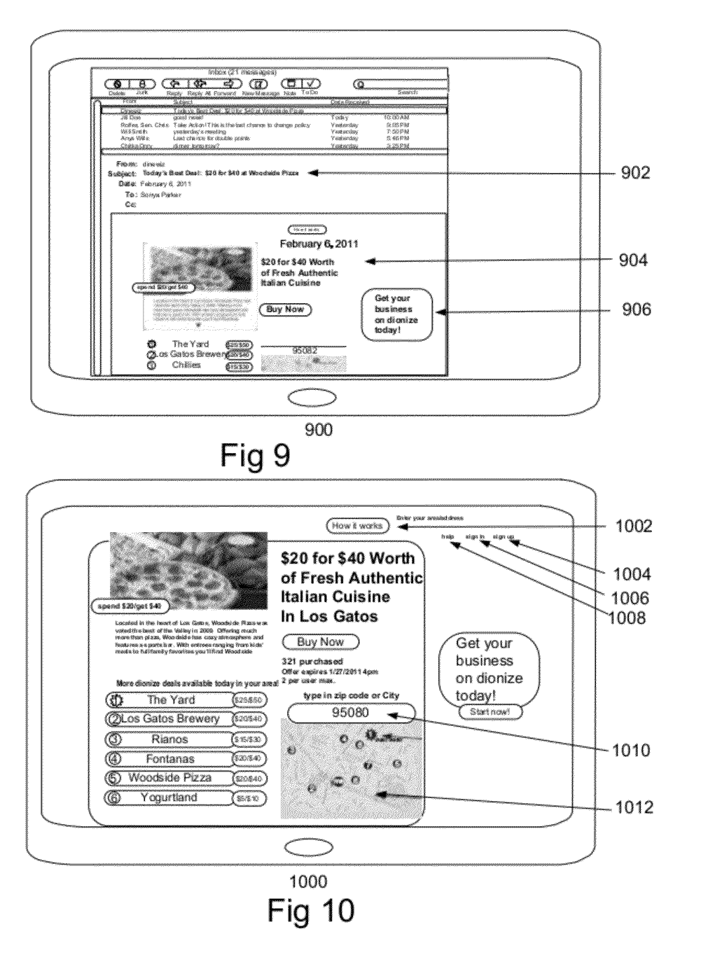

In some example embodiments the Merchant/Seller interface will be a graphical user interface (GUI) displayed, for example by a browser, on the Merchant/Seller device. An example of the interface is described below with reference to FIGS. 9-12.

The Merchant/Seller interface facilitates creation of information, the storage of information on the server and modification of information stored on the server. It also allows the Merchant/Seller to instruct the server to perform operations such as posting electronically offered discounts on customer/user devices and other functions described below.

Among the types of information that can be created, stored or modified are profile, access, location, discount offer, time frame, restrictions, company information, pictures, etc. Among the type of operations that can be performed are review, submit, edit, etc.

For example, when the Merchant/Seller decides to offer a real time discount the Merchant/Seller interface 110 is used to enter a profile 126, access other screens 127, specify the location 128 if this information is not already stored on the server, create a discount offer 129, specify a time frame of the discount offer 130, specify any possible restrictions on the offer 131, enter company information 132 if not already stored, and provide a picture 133. Then the merchant can review the proposed discount offer 134 and submit it 135 in real time so that the offer is displayed for potential users within minutes of submission. Merchants can also go back and edit 136 the profile or discount information and resend it for submission in real time. The edit function can also allow the merchant to indicate that the offer is sold out or canceled.

A user interface 140 allows a user to enable Global Positioning System

(GPS) recognition 144, control access to other screens 145, create or enter a profile 146, view discount offers 147, confirm an order 148, verify credit 149, purchase a discount 150, store discount credit 152, access discount credit 153, and so on.

The merchant can interact with the user interface 140 to redeem 160 a discount.

FIG. 1B shows an enlarged view of the portable (mobile) multifunctional device 104. For example, if the portable multifunctional device 104 is a cellular telephone, then the portable device circuitry includes a communication link that may support protocols such as Global System for Mobile communication (GSM), General Packet Radio Service (GPRS), Enhanced Data Rates for Global Evolution (EDGE), Universal Mobile Telecommunications Service (UMTS), etc. The communication interface of the device 104 may also/alternately support Wireless Wide Area Network (WWAN), Wireless Local Area Network (WLAN), and/or Wireless Personal Area Network (WPAN), etc.

Device 104 may further include a contactless element 164, typically implemented in the form of a semiconductor chip 164(a) with an associated wireless data transfer (e.g., data transmission) element 164(b), such as an antenna. Contactless element 164 is associated with (e.g., embedded within) portable device 104 and data such as a coupon or control instructions transmitted via cellular network may be applied to contactless element 164 by means of contactless element interface 166. Contactless element interface 166 functions to permit the exchange of data and/or control instructions between the portable device circuitry 162 (and hence the cellular network) and contactless element 164.

The contactless element may also include a Near Field Communication (NFC) module or other near field wireless reader module that allows the portable multifunctional device to communicate with a point of sale terminal (POS) at a merchant location by tapping the portable multifunctional device to a reader.

Contactless element 164 is capable of transferring and receiving data using a near field communications capability (or near field communications medium) typically in accordance with a standardized protocol or data transfer mechanism (identified as ISO 14443/NFC in the figure). Near field communications capability is a short-range communications capability, such as RFID, infra-red, or other data transfer capability that can be used to exchange data between the portable device 104 and a local apparatus by tapping the portable device to the local apparatus, for example located at point-of-sale of a merchant or another location at which coupons are expected to be redeemed. Thus, portable device 104 is capable of communicating and transferring data and/or control instructions via both cellular network and near field communications capability.

Portable device 104 may also include a secure data space 168, which may be used by the device to store operating parameters and/or other data utilized in operation of the device. The secure data space 168 may be in the form of a chip that is separate and apart from the chip in the contactless element 164, or alternatively, could be a section of memory in the chip that forms part of the contactless element 164. Note that the chip in the contactless element 164 may include data storage capability in the form of a memory that may be accessed via interface 166 to permit the implementation of read, write, and erase functions, for example.

In accordance with still other embodiments, the portable device may further include a processor 170 and computer readable storage medium 172 for storing code and configured to direct the processor to perform various tasks. For example, the computer readable storage medium may comprise a magnetic disk drive or a flash memory chip. A smart phone includes an operating system such as Google Android or Apple iOS operating system.

The computer readable storage medium may contain code that is configured to cause a processor of the portable consumer device to receive and recognize a message including a coupon and code that is delivered to the portable device. The computer readable storage medium may also include code that is configured to decrypt an encrypted message including the code that is received by the portable device.

In accordance with certain embodiments, the portable device 104 further includes a Global Positioning System (GPS) element 174. GPS element 174 is configured to allow determination of the location of the user at any time. In particular, GPS element 174 relies upon signals from a plurality of orbiting satellites in order to allow the user's location to be determined. Location information obtained from the GPS element 174 may in turn be communicated through the antenna to allow monitoring of the user's position. The GPS receiver determines a geographic location for the device by calculating a distance between the device and at least three satellites using low-power radio signals received from the satellites using a technique known as Trilateration, which is known in the art.

The portable multifunctional device includes an input interface 176 such as, for example, a touch screen, keypad (which for present purposes will be understood to include the other buttons, switches and keys referred to or may be implemented as soft keys on the display) for receiving user input, a display component for displaying output information to the user and conventional receive/transmit circuitry. Other suitable input interfaces include a light pen, track ball, data glove, microphone, etc. The portable multifunctional device also includes an input/output interface that may include a keypad, a mouse, a screen, a touch screen, and/or any other type of interface that allows a user of the device to interact with the device.

FIG. 1C is an illustration of basic subsystems in server system 100 of FIG. 1A. This diagram is merely an illustration and should not limit the scope of the claims herein. One of ordinary skill in the art will recognize other variations, modifications, and alternatives. In certain embodiments, the subsystems are interconnected via a system bus 1675. Additional subsystems such as a printer 1674, keyboard 1678, fixed disk 1679, monitor 1676, which is coupled to display adapter 1682, and others are shown. Peripherals and input/output (I/O) devices, which couple to I/O controller 1671, can be connected to the computer system by any number of means known in the art, such as serial port 1677. For example, serial port 1677 can be used to connect the computer system to an external interface, such as a modem, 1681, which in turn connects to a wide area network such as the Internet, a mouse input device, or a scanner. The interconnection via system bus 1675 allows central processor 1673 to communicate with each subsystem and to control the execution of instructions from system memory 1672 or the fixed disk 1679, as well as the exchange of information between subsystems. Other arrangements of subsystems and interconnections are readily achievable by those of ordinary skill in the art. System memory and the fixed disk are examples of tangible media for storage of computer programs. Other types of tangible media include floppy disks, removable hard disks, optical storage media such as CD-ROMS and bar codes, and semiconductor memories such as flash memory, read-only-memories (ROM), and battery backed memory.

Any of the software components or functions described in this application may be implemented as software code to be executed by a processor using any suitable computer language such as, for example, Java, C++ or Perl using, for example, conventional or object-oriented techniques. The software code may be stored as a series of instructions or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

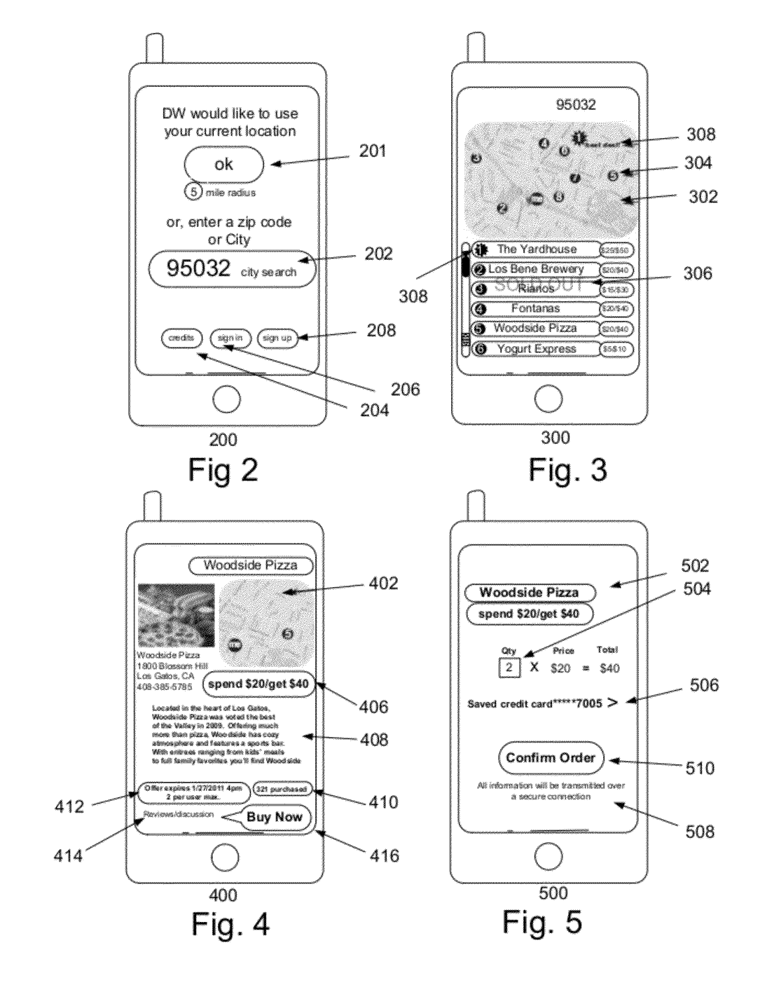

An example of interactions between the merchant/seller, server and user devices to create, select, purchase and redeem an electronically offered discount will now be described with references to FIGS. 2 to 14, which are screen shots produced by user interface on the portable multifunctional and/or non-portable devices. The screen shots displayed include active areas that allow data and messages to be exchanged between the devices and the server.

In example embodiments the creation, display and interaction results from the execution of applications may be local to the device or distributed between the device and one or more servers connected to a network. In some embodiments, an application executing on the portable device uses the resources of an operating system such as Android, iOS, etc. for mobile phones and an application executing on a PC or Apple computer could utilize Windows, Unix, MacOS, etc.

Additionally, if the devices are connected over the Internet then the capabilities of standard browser applications such as Firefox, Internet Explorer or Chrome would also be utilized by the applications.

FIGS. 2-8 depict screen shots of an example customer user interface on a user's portable device that allows a user to interact with the server and a merchant to purchase, manage and redeem electronically offered discounts. In this example embodiment, a discount transaction application is downloaded and stored on the portable device. This application uses resources provided by the operating system, for example the SyncAdapter service provided by the Android operating system, to synchronize with the server. Alternatively, synchronization can be maintained by exchanging messages with the server.

The user interface enables the user to activate GPS recognition, control access information, create and manage a user profile, view and accept discount offers, confirm purchases, verify credit, store discount credits locally or on the server, access discount credits, etc. The details of example embodiments of the user interface will be described more fully below.

The user interface on the customer's portable device can be utilized by the Merchant/Seller to allow redemption of a discount at the point of sale location. Examples of redemption will be described more fully below.

Using the portable multifunctional device 104, or a non-portable device 108, a user can access the application stored on the portable device and begin the process of finding the discount offer. The user is lead through a series of screens and moves forward by answering the questions.

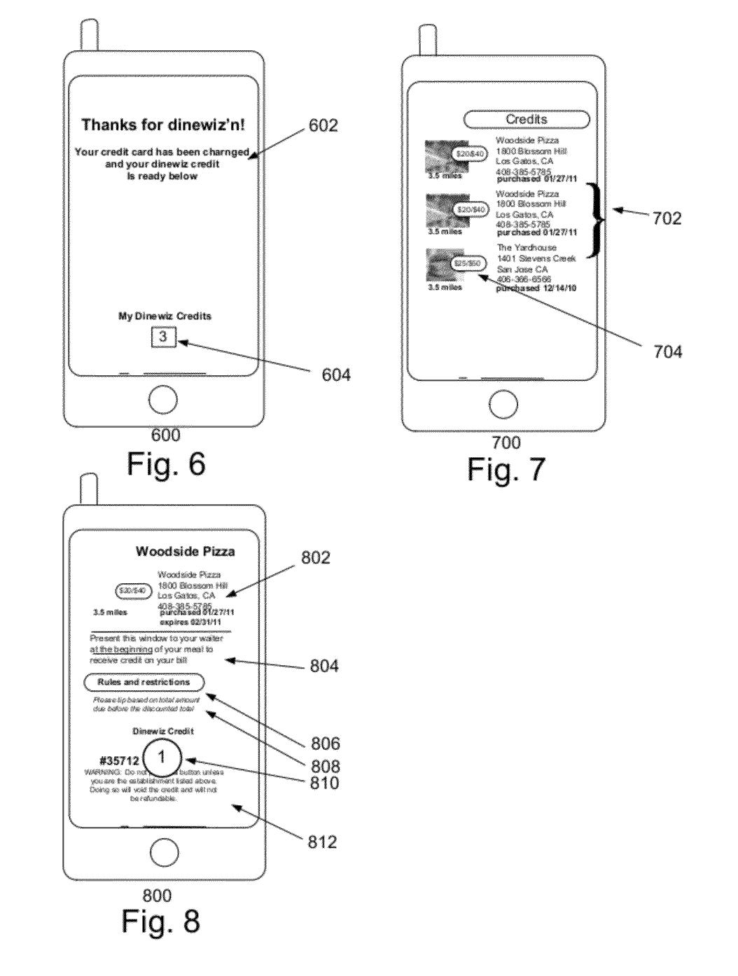

For example, a user may first use the interface screen depicted in FIG. 2 to access current merchant discount offers in a locality based on the user's location determined by using the GPS or a selected zip code. The user then views and selects a discount offer using the user interfaces depicted in FIGS. 3 and 4. Then the user may confirm the order, verify credit information, and confirm the purchase of the electronically offered discounts using the user interface depicted in FIG. 5. The number of credits is confirmed to the user by the user interface depicted in FIGS. 6 and 7.

Once the user has arrived at the merchant destination, the discount credit is accessed and redeemed by presenting the user interface depicted in FIG. 8 to an employee at merchant destination or, in another example embodiment, by tapping the portable multifunctional device to a reader or another portable multifunctional device at the location. Then the merchant pushes the button activating and deleting the credit. In this example, this information coming from the merchant and user is all stored at the server.

Each of the user interface screens depicted in FIGS. 2-8 will now be described in detail.

FIG. 2 illustrates example portable multifunctional devices with a touch-sensitive display showing an example user interface and home screen that is generated by an application executing on the portable multifunctional device. The home screen 200 prompts the user to select a mode of identifying the user's location. The screen includes buttons for prompting a user to select either a GPS mode 201 or a zip code/city select mode 202. The GPS mode uses the current location of the portable device as is determined by GPS signals and prompts the selection of a radius about the current location that defines a circle for selecting which merchants' discounts will be displayed.

The example home screen 200 also includes buttons for accessing a credits screen 204, a sign in screen 206 and a sign up screen 208. Accordingly, the user has the option of going directly to the discount credits already purchased or to sign up if using the application for the first time.

If a user touches the sign up button 208 a series of screens (not shown) will prompt the user to create a user profile which includes, for example, a user name, pass word, payment card number, payment method, e.g., PayPal, Google Wallet, PayPass, etc.

The user profile can also include preferences such as types of food preferred, brand names preferred, price points preferred, etc. Note that although specific forms of payment and money or credit transactions are described, other forms are possible. Steps can be added to, removed from, or changed from those described herein and yet still remain within the scope of the claims. In general, any suitable form of accomplishing the money or credit part of the transaction can be used with various features described herein.

FIG. 3 is an example merchant offer screen 300 that illustrates a GPS map 302 displaying merchant discount offers located within a certain mile radius of the user. A street map of the local area is displayed with numbers 304 indicating the locations of merchants offering a discount.

A list of offers is also displayed with each element 306 in the list including a number corresponding to the merchant number displayed on the map, the merchant name and the details of the discount. The first merchant offer displayed is marked as the best deal 308 and is also highlighted by a star graphic. The user can select an offer by touching the circle with a number on it or the user can scroll down the list to display and choose other discount offers. If a discount offer is sold out, the sold out offer is identified by “sold out” text overlaid and highlighted on the merchant name.

Alternatively, the number of offers remaining to be redeemed can be displayed. This number is updated in real time and provides an incentive to customers to redeem the offer and provides protection to the merchant.

There are several benefits to continuing to display an offer after it is sold out. The first is to generate a feeling of urgency for the users—if this discount offer has sold out then the others might also sell out soon. Secondly, the merchant is given free advertising beyond the time of the offered deal. And thirdly, it shows users that many other users are buying and are satisfied that the site is solid and trustworthy.

Alternatively, a discount offer can be removed from the screen when it is sold out.

FIG. 4 is an example of a discount offer detail screen 400 that illustrates a detailed description of the discount offer including such features as the offer expiration date, the start and finish times that the offer can be redeemed, and the total purchased updated in real time. In this example the discount offer detail screen for a particular discount offer is accessed by selecting a discount offer listed on the merchant offer screen 300.

The displayed map 402 now shows only the discount offer merchant of choice. The discount offer is clearly stated 406. Also displayed is the merchant address, telephone number and a description 408 of the merchant was created by the merchant. The quantity of discount offers that have been purchased 410 is shown in real time along with the expiration date and any other restrictions 412.

Users can touch a “Review/Discussion” button 414 to add reviews or enter a discussion of the merchant making the discount. The user touches the “Buy Now” button 416 to access a purchase screen.

FIG. 5 is an example of a purchase screen 500 that includes information and buttons to guide the user through the purchase of the discount offer. The merchant and discount offer selected are displayed 502. A quantity window 504 allows the user to enter the number of discount offers to be purchased. This can be done using a pop-up keyboard or a scroll icon that appears in the window. In this example, the quantity will have an upper limit controlled by the merchant. Credit card information from the user profile is also displayed. The user has the option of choosing a different credit card 506. The disclaimer 508 at the bottom of the screen reads that all information will be transmitted over a secure connection. The purchase is completed by touching the “Confirm Order” button 510.

FIG. 6 is an example confirmation screen 600 that is displayed after the “Confirm Order” button of the purchase screen 500 is touched. The confirmation screen illustrates economization of the order and the venue to redeem the purchased credits. The user is told that credit card has been charged 602 and the number of discount offer credits is shown at the bottom of the screen in a credits window 604. Once the credit has been used, the number displayed in the credits window drops to a lower value to coincide with the number of remaining credits.

FIG. 7 is an example detailed purchased credits screen 700 that is displayed when the credits window 604 is touched. The detailed purchased credits screen illustrates a detailed breakdown of purchased credits not yet redeemed 702. The user can click on the picture, offer, or address text to be taken to the next screen to redeem. The discount offer of each credit is shown 704.

FIG. 8 is an example discount offer redemption screen 800 which is accessed by touching a selected purchased credit on the detailed purchased credits screen 700. The offer redemption screen illustrates in detail the selected purchased credit that is to be redeemed by the merchant at the merchant's physical location. The user can press on the telephone number 802 listed and be connected directly to the merchant if desired.

In this example, instructions are displayed for redeeminb the discount offer. The instructions 804 read: present this window to your waiter at the beginning of your meal to receive credit on your bill. Users may also touch the “Rules and Restrictions” button 806 to view rules and restrictions of the particular discount offer. Users are also instructed 808 to tip the service provider based on the total amount of the bill before the discount total.

Once the merchant or an agent of the merchant touches the credit button 810, the amount shown goes from “1” to “0”. The user is given a warning 812 below the credit button which reads: Do not push this button unless you are in the establishment listed above. Doing so will void the credit and will not be refundable.

Alternate embodiments can require that the seller type in a code in order to decrement the credit number. The code can be provided by the managing Company or can be created by the seller. At a seller's establishment, different employees can be provided with different codes so that it is known who has accepted the credit.

Another embodiment may provide a seller's secret code which can be numbers, letters, an image or other identifying mark prior to the seller accepting the credit. This allows the seller to confirm that the coupon being redeemed is actually part of the promotion to which the seller has subscribed. For example, a seller might upload an image of a toaster by using a merchant interface (discussed below) when setting up the promotion. Then when the seller is presented with the buyer's phone to redeem the coupon the seller types in the seller's code and is presented with the toaster icon to confirm the proper coupon in the designated promotion is being redeemed. If the seller doesn't see the designated toaster image then a mistake is occurring or perhaps a fraud is in progress. Other variations on using codes or verifications to ensure the security of the coupon transaction are possible. It is not necessary to use all the steps proposed here. For example, a verification image can be used without requiring a seller to type in a code. Other approaches are possible.

In another embodiment, the discount offer can be redeemed by tapping the user's portable device to a seller's portable device. In this example, both devices include contactless interfaces, such as an NFC interface, and software to support exchanging information during a tap to redeem the discount offer.

In another embodiment, the redemption screen of the user interface can display a bar code or QR code that can be read by a seller's portable multifunctional device. In some embodiments, the discount can then be automatically calculated and applied to the user's bill or invoice.

FIGS. 2-8 depict a sequence of screen shots on a portable device 104 that form a user interface for viewing, selecting, purchasing and redeeming a discount offer.

Alternative user interfaces could use drop down lists, menus, etc. to implement the functionality described above.

FIG. 9 illustrates an example of a daily email screen 900 on a non-portable device giving the user notification of the day's best deal and other discount offers in the area for that day in real time. Once a user has registered and set up an email account, the user will be notified daily of today's best deal 902. If the user chooses to open the email, the screen opens showing the discount offer in detail 904. The user is taken to the main web page where the user can begin the research and purchase process. A merchant may also access the business portion of the website from this screen 906.

FIGS. 10-14 illustrate an example of a merchant interface for setting up and editing a merchant account and profile, creating and posting a discount offer, modifying or cancelling a discount, etc.

FIG. 10 illustrates an example home page 1000 viewed by a user or merchant to access the site information on a non-portable device. In the following description a non-portable device is used because of ease of data entry. However, all functions described can also be performed utilizing a portable multifunctional device. Users or merchants at any time can touch the “how it works” button 1002 to get a detailed description of how the business model works and review questions and answers. Merchants and users can click on “help’ button 1004 to get an answer to a specific question through email. Merchants and users can sign in and sign up using this screen by touching the “sign in” text 1006 or the “sign up” text 1008. Users can type in their zip code or city information in window 1010. The GPS driven map appears 1012 with various discount options. The first one displayed is marked as the best deal and is also highlighted by a star graphic. The user can click on the circle with the number on it or the user can scroll down the list and choose the discount offer. If a discount offer is sold out the user will identify that through the sold out text highlighted in the merchant name. The discount offer is displayed next to the merchant name. Merchants can also access the business portion of the site.

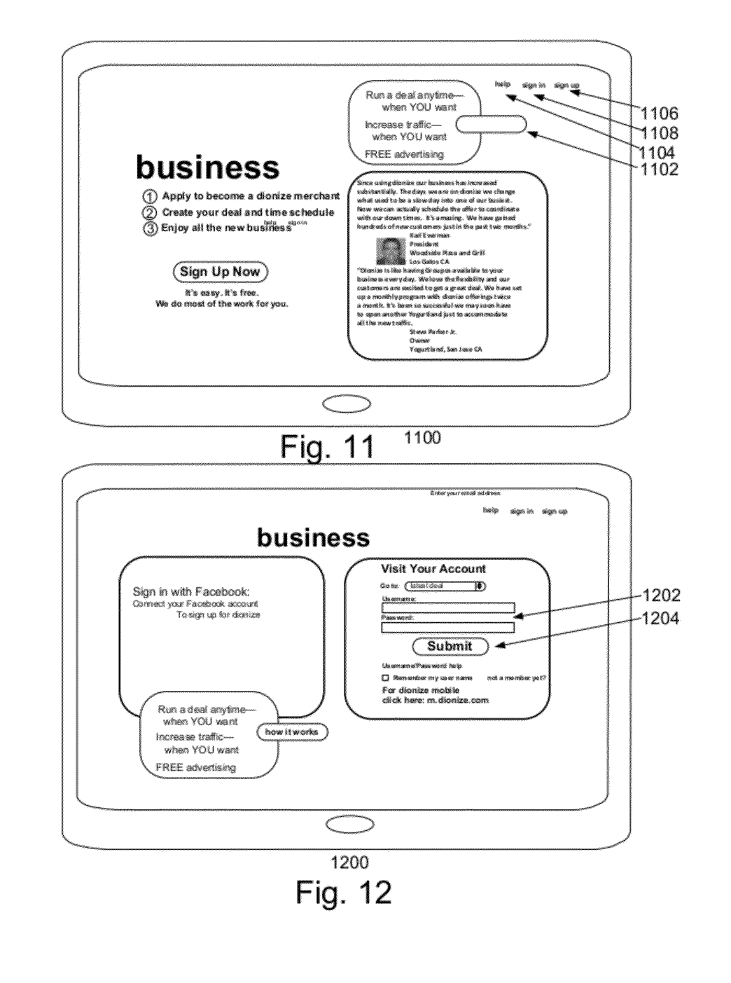

FIGS. 11-14 illustrate an example of a merchant interface for setting up and editing a merchant account and profile, creating and posting a discount offer, modifying or cancelling a discount, etc.

FIG. 11 illustrates the merchant site screen 1100 and the various options once a merchant has registered. Merchants, at any time, can select the “how it works” text 1102 to get a detailed description of how the business model works and review questions and answers. Merchants can click on “help” text 1104 to answer a specific question through email. Merchants sign up their businesses for the first time by clicking “sign up” text 1106 . Merchants read testimonials from other merchants and read benefits of registering and using the service. A merchant access screen is activated by touching the “sign in” text 1108.

FIG. 12 illustrates a merchant access screen 1200 allowing a merchant to access its particular site using a password clearance or through a facebook or other social media account such as twitter, Google+, etc. If the merchant is a returning merchant, the merchant logs in using the username and password windows 1202 that have been set up. Once this information is entered, the submit button 1204 is hit to enter the site. If the merchant forgets the password it can be accessed again with a message being sent to the merchant's email account. Merchants can also sign in using their facebook or other social media account if such access has been previously set up. Merchants can also link onto the portable site from this page.

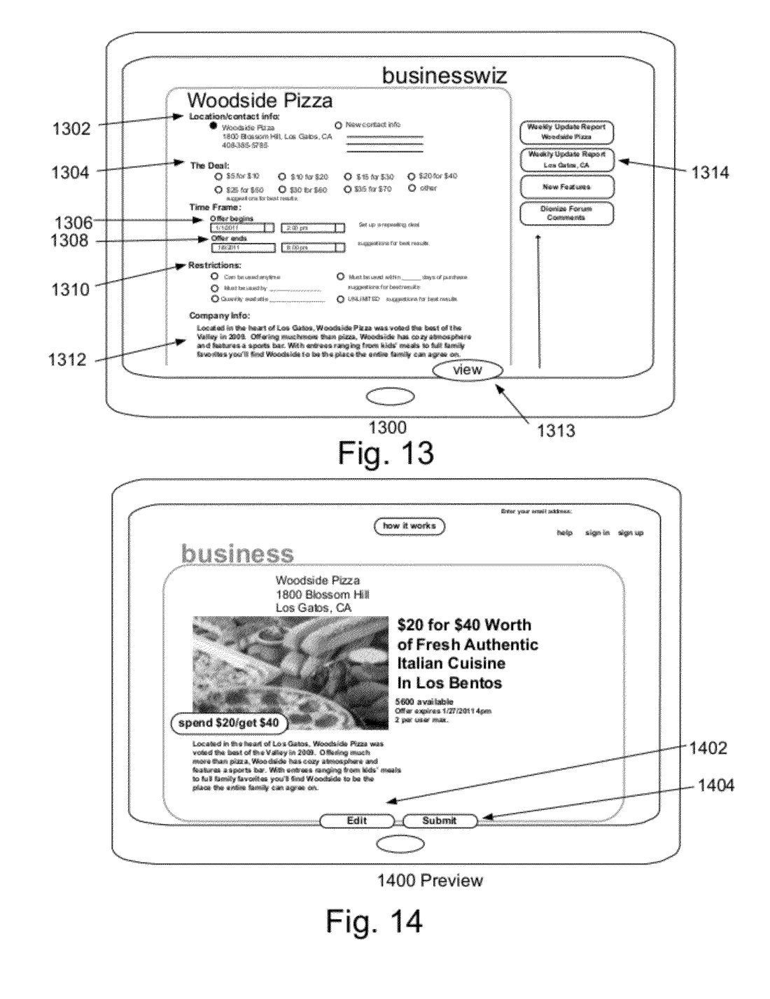

FIG. 13 illustrates a real-time discount creation screen 1300 and the detailed information a merchant enters to post a real-time discount offer on the server for distribution to portable and non-portable devices. The location/contact information of the merchant is entered at location/contact information area 1302 and includes, for example, the street address, telephone number, web site, etc. Next, the discount deal is selected by activating a radio button next to one of a list 1304 of pre-defined deals or a user-defined deal. Deals are in the form of, for example, $5 for $10, which means that the user obtains $10 of goods or services by paying $5 to the managing company. In other embodiments, other ways to specify the deal can be used such as by allowing the merchant to enter a deal description in free-form text, etc. The time frame specifying the beginning and ending of the discount offer is entered using, in this example, drop down lists 1306 and 1308 or the merchant pulls up a calendar for easy date choice and retrieval. Restrictions on the discount offer can be selected using radio buttons 1310. Information about the merchant, including pictures, can be selected from the profile and displayed in the company information field 1312. A preview can be generated by selecting the view button 1313.

The deal (coupon) redemption site can be the location specified at 1302, can be obtained from a predefined profile from the merchant, can be included as one or more additional addresses or locations, or can be specified by other means. Locations can be specified by GPS coordinates or any suitable measurement or mechanism. In other embodiments (not shown), the merchant can be provided with an “enforce GPS location checking” option that can cause the system to check to make sure at the time of redemption that the redeeming device (e.g., the buyer's cell phone) is at, or sufficiently close to, the GPS location of the redemption site.

Text fields can be selected to sign up for a repeating deal and get suggestions for best results. Repeating deals are useful if the merchant discovers that a particular time, for example Friday afternoon, is slow. The discount can be set up once and automatically repeats.

Buttons 1314 allow access to weekly update reports, new features and a forum.

FIG. 14 illustrates discount preview screen 1400 showing how the discount offer will look when displayed on users' devices, for example, as depicted in FIG. 4. Merchants have the option to either submit or edit the current discount offer in real-time by selecting either the Edit or Submit buttons 1402 and 1404.

If the Edit button 1402 is selected the real-time discount creation screen 1300 is displayed again to allow editing of the real-time discount offer to change the location, the discount offer, the time frame, the restrictions, the company information, etc. The merchant can still access help if needed.

If the Submit button 1404 is selected then the real-time discount offer is posted to the server using the communication links described above with reference to FIG. 1. Software executing on the server then transmits the offer to the user's portable device in real time based on, for example, location and preferences in user profiles stored on the server.

If the preview screen 1400 is accessed after submission of the discount offer then the Submit button is replaced by a Cancel button. If the Cancel button is activated then a message to the server is sent that causes the server to notify all users that have received the offer that the offer has been canceled.

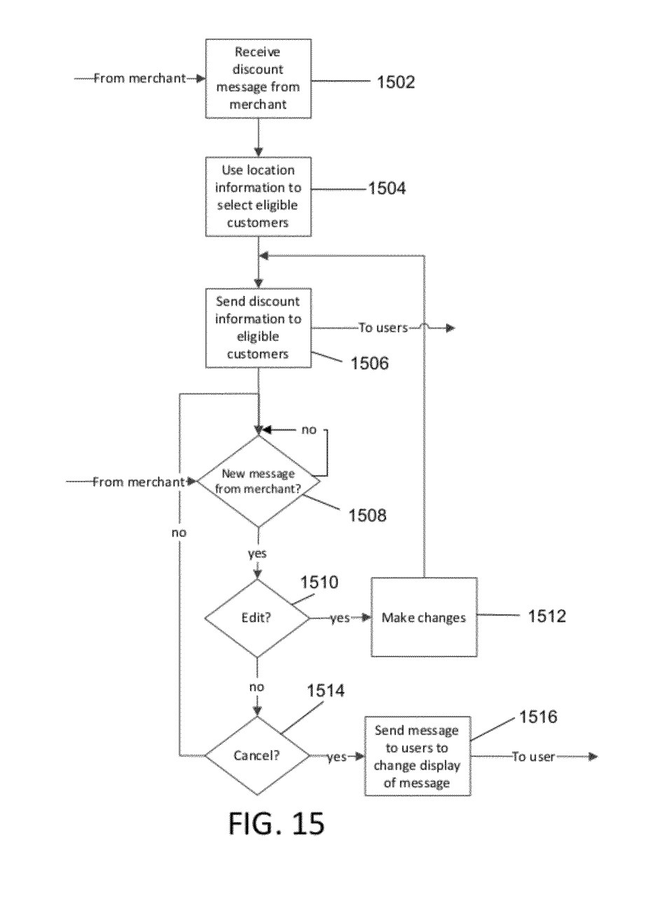

FIG. 15 is a flow chart depicting steps performed by the server during a discount offer distribution transaction. In an example embodiment, the server is operated by a managing company that provides services both to merchants and customer users. In process step 1502 the server receives a new discount message created at the merchant's device when the submit button is activated.

In process step 1504 the location data in a new discount message is compared to the location data stored in user profiles to determine a list of eligible users. Additional information such as user preferences can also be processed to broaden or narrow the list of eligible users.

In process step 1506 the discount information will be transmitted to the user devices within a specified time period and is used by the application on the user's portable device to generate, for example, the merchant offer screen depicted in FIG. 3. For example, if discount offers are specified to begin on the hour then if the specified time period were fifteen minutes the offer would be transmitted soon enough that the transmission of the offer would appear to be in real time to the merchant. If the information were transmitted as at about the same time as messages from the merchant were received then the transmission of the offer would appear almost instantaneous to the merchant.

In process step 1508 the process waits for a message from the merchant and if a message is received proceeds to process step 1510 where it is determined whether the message is an edit message. If no, then the process loops. If yes, then in process step 1512 changes are made to the offer and the changes are sent to the user devices.

For example, a merchant offer screen could include the number of discounts remaining. If a restaurant had 10 pizzas on sale then the number of pizzas could be decremented each time a pizza was sold.

In process step 1514 it is determined whether the message is a cancel offer message. If yes, then in process step 1516 a message is sent to the user devices to change the display for this message. For example, as depicted in FIG. 3 the words “SOLD OUT” could overlay the display of the discount offer.

The process steps depicted in FIG. 15 allow a merchant to fine tune offers in real time and give customers the benefit of access to special discounts available right now in their locality. An active local community of buyers and sellers is created.

Various example embodiments have been described above. Alternatives and substitutions will now be apparent to persons of skill in the art. Accordingly, it is not intended to limit the invention except as provided by the appended claims.

What is claimed is:

1. An apparatus coupled to a communication link to a merchant and plurality of customer portable device, with the apparatus comprising:
a processor;
a memory coupled to the processor storing program code and data used by the processor;
with the processor configured to execute program code to receive a message from a merchant specifying a merchant location, terms of a discount offer, and start and stop times of the discount offer, to determine a list of customer portable devices at specified customer locations having a defined relationship to the merchant location and to transmit the terms, the start time and the stop time of the discount offer to the customer portable device in the list.

1. A method for creating an online coupon, the method executing on a computer system including a processor coupled to a display and to one or more user input devices, the method comprising:
displaying information on the display screen, wherein the displayed information is related to creating an online coupon;
accepting a signal from the one or more user input devices to specify a location for the online coupon;
accepting a signal from the one or more user input devices to specify a time during which the online coupon can be redeemed;
accepting a signal from the one or more user input devices to specify a deal term for the online coupon;
providing a control to submit an offer for the online coupon that uses the specified location, time and term;
automatically making the online coupon viewable on multiple user devices; and
automatically handling redemption of the online coupon so that a user who complies with the online coupon's specifications can redeem the online coupon.

2. The method of claim 1, further comprising:
accepting a signal from the one or more user input devices to specify a rule for the coupon.

3. The method of claim 1, further comprising:
accepting a signal from the one or more user input devices to specify a restriction for the coupon.

4. The method of claim 1, further comprising:
accepting a signal from the one or more user input devices to allow a description for the coupon.

5. The method of claim 4, wherein the description is entered as free-form text.

6. The method of claim 1, further comprising:
accepting a signal from the one or more user input devices define multiple locations for the coupon.

7. The method of claim 1, further comprising:
accepting a signal from the one or more user input devices to allow Global Positioning Satellite (GPS) specification of one or more locations.

8. The method of claim 1, further comprising:
accepting a signal from the one or more user input devices to use the GPS location of a particular user device when permitting the particular user device to redeem the coupon.

9. An apparatus for creating an online coupon, the apparatus comprising:
a computer system including a processor coupled to a display and to one or more user input devices, the method comprising the following acts performed by the processor:
displaying information on the display screen, wherein the displayed information is related to creating an online coupon;
accepting a signal from the one or more user input devices to specify a location for the online coupon;
accepting a signal from the one or more user input devices to specify a time during which the online coupon can be redeemed;
accepting a signal from the one or more user input devices to specify a deal term for the online coupon;
providing a control to submit an offer for the online coupon that uses the specified location, time and term;
automatically making the online coupon viewable on multiple user devices; and
automatically handling redemption of the online coupon so that a user who complies with the online coupon's specifications can redeem the online coupon.

10. A processor-readable storage device including instructions executable by a processor, wherein the processor is coupled to the storage device, display screen, and one or more user input devices, the processor-readable storage device comprising one or more instructions for:
displaying information on the display screen, wherein the displayed information is related to creating an online coupon;
accepting a signal from the one or more user input devices to specify a location for the online coupon;
accepting a signal from the one or more user input devices to specify a time during which the online coupon can be redeemed;
accepting a signal from the one or more user input devices to specify a deal term for the online coupon;
providing a control to submit an offer for the online coupon that uses the specified location, time and term;
automatically making the online coupon viewable on multiple user devices; and
automatically handling redemption of the online coupon so that a user who complies with the online coupon's specifications can redeem the online coupon.
